(19) United States
(12) Patent Application Publication
(10) Pub. No.: US 2016/0048164 A1
(43) Pub. Date: Feb. 18, 2016

(54) Laptop Computer Closing Assembly

(71) Applicant: Ricardo Dunkley, Austin, TX (US)

(72) Inventor: Ricardo Dunkley, Austin, TX (US)

(21) Appl. No.: 14/457,773

(22) Filed: Aug. 12, 2014

(51) Int. Cl. G06F 1/16

(52) U.S. Cl. CPC G06F 1/1616

(57) ABSTRACT

A laptop computer closing assembly includes a laptop computer structured to have a screen hingedly coupled to a keyboard. A pair of gears is coupled to the laptop computer. A first one of the gears drives a second one of the gears. The second gear is coupled to the screen. The second gear moves the screen between an open position so the laptop computer is configured to boot up and a closed position so the laptop computer may shut down. A motor is coupled to the laptop computer. The motor is operationally coupled to a processor in the laptop computer. The motor is coupled to the first gear. The screen is moved between the open and closed positions. An actuator is coupled to the laptop computer. The actuator is operationally coupled to the processor in the laptop computer. The actuator selectively actuates and de-actuates the motor.

### BACKGROUND OF THE DISCLOSURE

### Field of the Disclosure

The disclosure relates to closing devices and more particularly pertains to a new closing device for automatically opening and closing a laptop computer.

### SUMMARY OF THE DISCLOSURE

An embodiment of the disclosure meets the needs presented above by generally comprising a laptop computer structured to have a screen hingedly coupled to a keyboard. A pair of gears is coupled to the laptop computer. A first one of the gears drives a second one of the gears. The second gear is coupled to the screen. The second gear moves the screen between an open position so the laptop computer is configured to boot up and a closed position so the laptop computer may shut down. A motor is coupled to the laptop computer. The motor is operationally coupled to a processor in the laptop computer. The motor is coupled to the first gear. The screen is moved between the open and closed positions. An actuator is coupled to the laptop computer. The actuator is operationally coupled to the processor in the laptop computer. The actuator selectively actuates and de-actuates the motor.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a laptop computer closing assembly according to an embodiment of the disclosure.

FIG. 2 is a top perspective view of an embodiment of the disclosure.

FIG. 3 is a back view of an embodiment of the disclosure.

FIG. 4 is a cross sectional view taken along line 4-4 of FIG. 3 of an embodiment of the disclosure.

FIG. 5 is a schematic view of an embodiment of the disclosure.

### DESCRIPTION OF THE PREFERRED EMBODIMENT

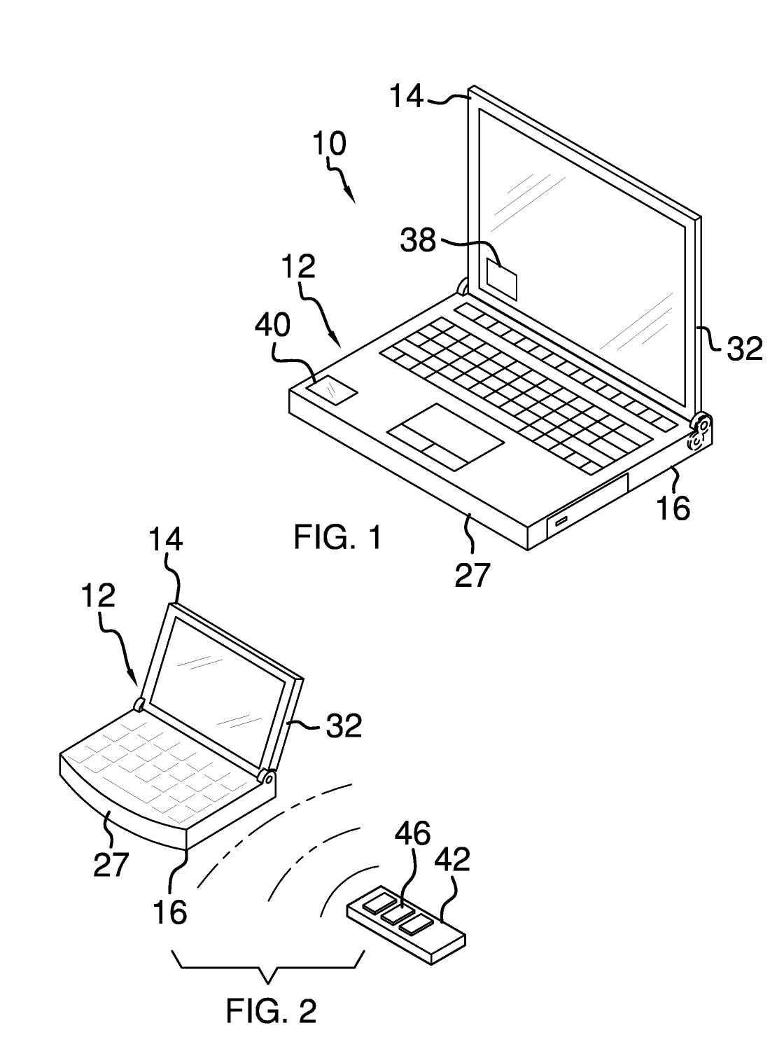

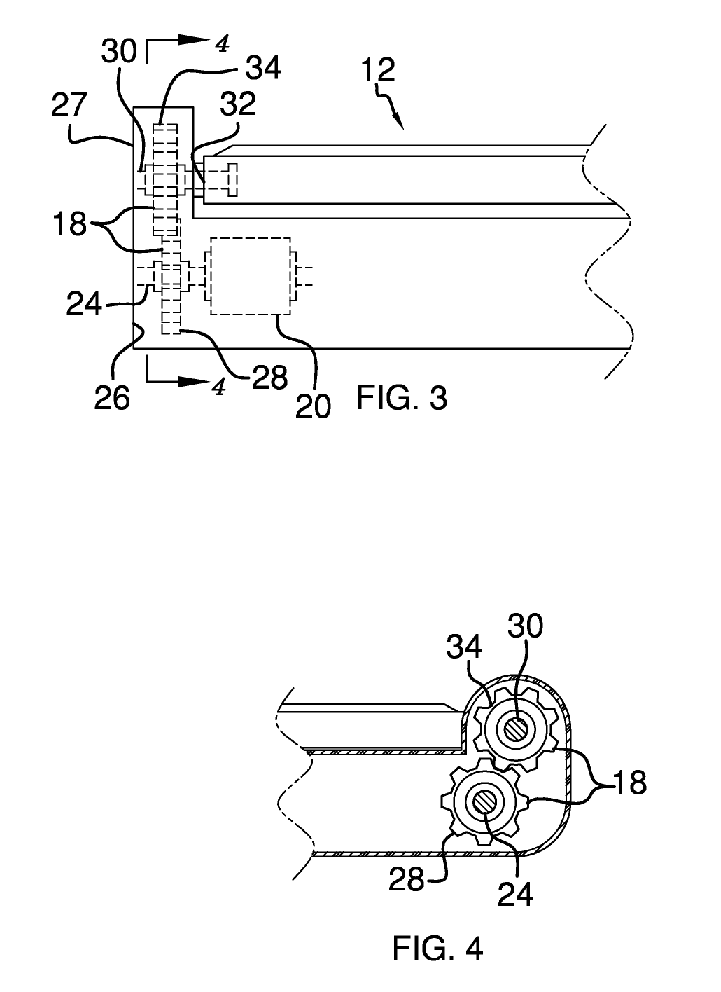

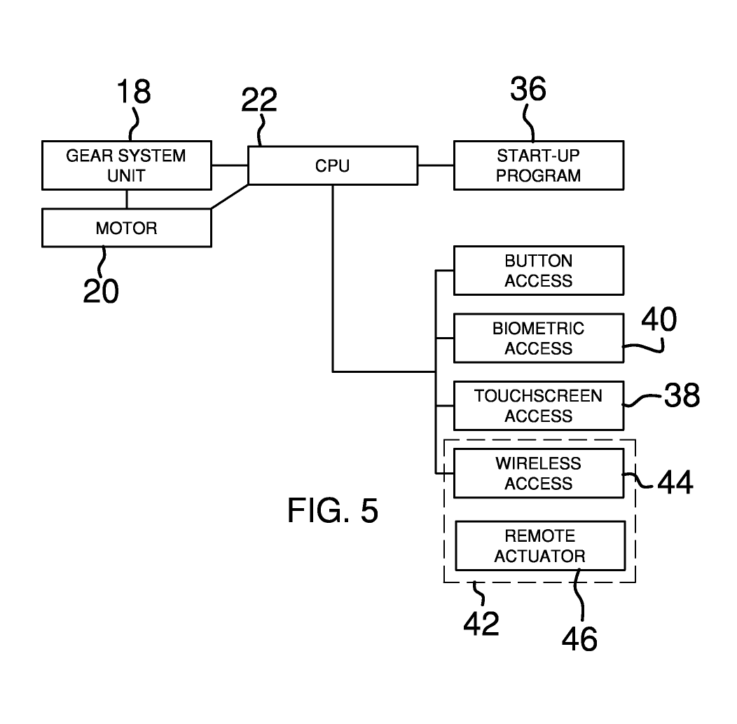

With reference now to the drawings, and in particular to FIGS. 1 through 5 thereof, a new closing device embodying the principles and concepts of an embodiment of the disclosure and generally designated by the reference numeral 10 will be described.

As best illustrated in FIGS. 1 through 5, the laptop computer closing assembly 10 generally comprises a laptop computer 12 structured to have a screen 14 hingedly coupled to a keyboard 16. The laptop computer 12 may be of any conventional design. A pair of gears 18 is rotatably coupled to the laptop computer 12.

A motor 20 is coupled to the laptop computer 12. The motor 20 is positioned within an interior of the keyboard 16. The motor 20 is electrically coupled to a processor 22 in the laptop computer 12. The processor 22 may be a laptop computer processor of any conventional design. Additionally, the motor 20 may be an electric motor of any conventional design.

A first shaft 24 is rotatably coupled between an inside surface 26 of an outer wall 27 of the keyboard 16 and the motor 20. The first shaft 24 extends through a first one 28 of the gears 18. The first gear 28 is rotatably coupled to the motor 20.

A second shaft 30 is rotatably coupled between the inside surface 26 of the outer wall 27 of the keyboard 16 and a first lateral edge 32 of the screen 14. The second shaft 30 extends through a second one 34 of the gears 18. Moreover, the second gear 34 is positioned upwardly from the first gear 28. The first gear 28 drives the second gear 34.

The second gear 34 moves the screen 14 between an open position and a closed position. The laptop computer 12 may boot up when the screen 14 is positioned in the open position. Additionally, the laptop computer 12 may shut down when the screen 14 is positioned in the closed position. The laptop computer 12 contains a program 36 that boots the laptop computer up and shuts the laptop computer 12 down relative to the positioning of the screen 14. Additionally, the program 36 positions the screen 14 at a pre-determined angle with respect to the keyboard 16 when the motor 20 moves the screen 14 into the open position.

The program 36 includes an icon 38 displayed on the screen 14. The icon 38 is utilized in the convention of a graphic user interface to actuate and de-actuate the motor 20 and the program 36. The program 36 includes a timer function. The timer function allows a duration of time to be set for the screen 14 to automatically be positioned in the closed position and the laptop computer 12 to be shut down.

An actuator 40 is coupled to the outer wall 27 of the keyboard 16. The actuator 40 is electrically coupled to the processor 22 in the laptop computer 12. The actuator 40 selectively actuates and de-actuates the motor 20. Moreover, the actuator 40 may be a fingerprint reader of any conventional design.

A remote control 42 is provided. A remote transceiver 44 is coupled to the remote control 42. The remote transceiver 44 is in electromagnetic communication with the processor 22 in the laptop computer 12. The remote transceiver 44 may be an RF transceiver of any conventional design.

A remote actuator 46 is coupled to the remote control 42. The remote actuator 46 is electrically coupled to the remote transceiver 44. The remote transceiver 44 communicates an open signal or a close signal to the processor 22 in the laptop computer 12. The motor 20 opens and closes the screen 14 in relation to the command issued by the remote actuator 46.

In use, the actuator 40 is actuated to close or open the screen 14. The actuator 40 restricts use of the laptop computer 12 to an authorized user. The icon 38 is utilized to automatically open and close the laptop computer 12 at the pre-determined times. The remote control 42 is utilized to open or close the laptop computer 12 from a distance.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A laptop computer closing assembly comprising:
a laptop computer structured to have a screen hingedly coupled to a keyboard;
a pair of gears coupled to said laptop computer, a first one of said gears driving a second one of said gears, said second gear being coupled to said screen such that said second gear moves said screen between an open position wherein said laptop computer is configured to boot up and a closed position wherein said laptop computer is configured to shut down;
a motor coupled to said laptop computer, said motor being operationally coupled to a processor in said laptop computer, said motor being coupled to said first gear such that said screen is moved between said open and closed positions; and
an actuator coupled to said laptop computer, said actuator being operationally coupled to said processor in said laptop computer such that said actuator selectively actuates and de-actuates said motor.

2. The laptop computer closing assembly according to claim 1, said motor being positioned within an interior of said keyboard, a first shaft rotatably coupled between an inside surface of an outer wall of said keyboard and said motor.

3. The laptop computer closing assembly according to claim 2, further comprising said first shaft extending through said first gear such that said first gear is rotatably coupled to said motor.

4. The laptop computer closing assembly according to claim 1, further comprising a second shaft rotatably coupled between an inside surface of an outer wall of said keyboard and a first lateral edge of said screen.

5. The laptop computer closing assembly according to claim 4, further comprising said second shaft extending through said second gear such that said second gear is positioned upwardly from said first gear.

6. The laptop computer closing assembly according to claim 1, further comprising said motor being electrically coupled to said processor.

7. The laptop computer closing assembly according to claim 1, further comprising said actuator being coupled to an outer wall of said keyboard.

8. The laptop computer closing assembly according to claim 7, further comprising said actuator being electrically coupled to said processor.

9. A laptop computer closing assembly comprising:
a laptop computer structured to have a screen hingedly coupled to a keyboard;
a pair of gears coupled to said laptop computer;
a motor coupled to said laptop computer such that said motor is positioned within an interior of said keyboard, said motor being electrically coupled to a processor in said laptop computer;
a first shaft rotatably coupled between an inside surface of an outer wall of said keyboard and said motor, said first shaft extending through a first one of said gears such that said first gear is rotatably coupled to said motor;
a second shaft rotatably coupled between said inside surface of said outer wall of said keyboard and a first lateral edge of said screen, said second shaft extending through a second one of said gears such that said second gear is positioned upwardly from said first gear, said first gear driving said second gear such that said second gear moves said screen between an open position wherein said laptop computer is configured to boot up and a closed position wherein said laptop computer is configured to shut down; and
an actuator coupled to said outer wall of said keyboard, said actuator being electrically coupled to said processor in said laptop computer such that said actuator selectively actuates and de-actuates said motor.
